(19) United States
(12) Patent Application Publication
(10) Pub. No.: US 2018/0272476 A1
(43) Pub. Date: Sep. 27, 2018

(54) Preparation of Sn-based silver-graphene lead-free composite solders

(71) Applicant: Tianjin University, Tianjin (CN)

(72) Inventors: Lianyong XU, Tianjin (CN); Yongdian HAN, Tianjin (CN); Hongyang JING, Tianjin (CN); Lel ZHAO, Tianjin (CN); Xiaoqing LV, Tianjin (CN)

(73) Assignee: Tianjin University, Tianjin (CN)

(21) Appl. No.: 15/762,094

(22) PCT Filed: Sep. 23, 2016
(86) PCT No.: PCT/CN2016/099945

§ 371 Date: Mar. 21, 2018

(30) Foreign Application Priority Data
Sep. 25, 2015 (CN) 201510624582.5

(51) Int. Cl. B23K 35/26; B22F 9/04; B22F 1/00; B23K 35/40; C22C 13/00

(52) U.S. Cl. CPC B23K 35/262; B22F 9/04; B22F 1/0011; B23K 35/40; B22F 2201/20; B22F 2009/043; B22F 2304/10; B22F 2301/30; B22F 2201/11; C22C 13/00

(57) ABSTRACT

This invention discloses a method for preparing a kind of Sn-based silver-graphene lead-free composite solder, including mixing a certain amount of graphene with sodium dodecyl sulfate, then adding a certain amount of dimethylformamide, sonicating for 2 hours, adding a certain amount of silver nitrate to the mixture, continuing the sonication and finally obtaining the homemade. The solders matrix powder is weighed according to different silver-graphene mass fraction required, then poured into a ball-milling tank milling for 5 h. The powder is poured into a stainless steel mold after drying, then placed under hydraulic pressure to 500 Mpa for pressure forming. Later, the cold-pressed cylinder is placed in a high vacuum tube resistance furnace and sintered at 175° C. for 2 hours. After cooling to room temperature, it is formed into a cylinder under the hydraulic press. In this invention, graphene modified with Ag particles is selected as a strengthening material so as to improve the load-transfer between the graphene modified by nano-silver and the Sn matrix, aiming to achieve better strengthening effect.

### FIELD OF THE INVENTION

The present invention relates to a method of preparing a kind of composite solders by adding silver-graphene nanosheets to conventional 96.5Sn-3.0Ag-0.5Cu solders and using ball-milling process.

### BACKGROUND OF THE INVENTION

Tin-lead alloy solders has been used widely in the electronics industry for a long time, and its solders joint is an indispensable key part of electronic devices that provide mechanical support, circuit conduction and heat transfer channels as interlinking material between circuit devices, however, the lead is potentially harmful to human health and the natural environment. In addition with the development of microelectronics technology, electronic products are developing in the direction of miniaturization and portability, which makes the solders joints in electronic packaging more and more dense, the unit volume heat of electronic product running growing, the service temperature of solders joints higher and higher, but the traditional tin-lead alloy can't meet the requirements of the modern electronic industry due to its bad creep resistance. Therefore, it is necessary to develop a new lead-free solders with better performance.

Since the 1980s, people have made common efforts to research and develop the alternative of lead in electronic applications. The existing lead-free solders with mature technology are mainly composed of a series of alloys such as tin-copper, tin-silver-copper and tin-zinc, and in order to enhance the mechanical, thermal and electrical properties of the solders, researchers also add some strengthening phase to the traditional solders by using composite technology, aiming to further enhance the performance of the solders. Graphene has good mechanical, electrical and thermal properties and can be an excellent reinforcing phase for traditional solders, and its low density and favorable structural stability make it attractive for applications in the field of composite solders.

### SUMMARY OF THE INVENTION

In order to make improvement of the existing problem on graphene reinforced Sn-based solders that the difficulty of uniform distribution in the matrix and the poor bonding strength with the metallic matrix, so in this invention, graphene modified with Ag particles is selected as a strengthening material so as to improve the load-transfer between the graphene modified by nano-silver and the Sn matrix so as to achieve better strengthening effect. The purpose of this invention is to use silver-graphene nanosheet as strengthening phase, prepare the composite soldersing material by a ball-milling process which has the advantages of simple operation and excellent mixing effect. By testing the mechanical properties and wettability of the composite solders and the growth of the IMC layer, it is indicated that the silver-graphene composite solders prepared by the preparation method above has reliable performance and the application prospect is worth looking forward to.

In order to solve the above technical problem, this invention provides a method for preparing a Sn-basedsilver-graphene lead-free composite solders, which comprises the following steps:

Step 1, according to the mass ratio of 3:1 weighed graphene mixed with sodium lauryl sulfate as the mixture A, then uses a container to get some dimethylformamide, and the mixture A was added to dimethylformamide to obtain a mixture, wherein mass ratio of the mixture A to dimethylformamide is 1:1, the unit is mg/ml, and the mixture is sonicated for 2 hours;

Step 2, the molar concentration of 0.06 mol/ml of silver nitrate solution is added to a mixture of step 1, wherein the volume ratio of the silver nitrate solution to dimethylformamide is 1:2, sonicated for 30 minutes and filtered after heating for 1 hour at 70° C., followed by washing and alcohol cleaning, then silver-graphene nanosheets were obtained;

Step 3, taking 96.5Sn-3.0Ag-0.5Cu alloy powder as matrix material, the particle size of the matrix material is 25-45 μm. Appropriate amount of silver-graphene nanosheets as the reinforcing phase is take and mixed with the matrix material as the mixture B, wherein the mass percentage of the silver-graphene nanosheets is 0.03% to 0.1%;

Step 4, the mixture B is poured into a planetary ball mill tank, and added a certain amount of ethanol which is just cover the mixture B in the ball-milling tank and some stainless steel balls as a kind of ball-milling medium; then sealed vacuum and set argon as a protective gas to run at 300 r/min speed 5 h a matrix material and silver-graphene nanosheets fully mixed powder is obtained;

Step 5, after drying the mixed powder in step 4, it's poured into a diameter of 20 mm stainless steel mold and the uniaxial cold forming is carried out in a hydraulic press under 500 MPa pressure;

Step 6, the cylinder after cold-pressed in step 5 is put into a high vacuum tube resistance furnace, sintering at 175° C. for 2 h in vacuum, then it's take out after cooling to room temperature;

Step 7, the cylinder sample after sintering in step 6 is put into a punching mold, punched into a rod diameter of 6 mm in a hydraulic machine, then Sn-based silver-graphene lead-free composite solders is obtained.

Furthermore, in the step 3, the preferable mass percentage of the silver-graphene nanosheets is 0.03-0.05%, preferably 0.05%.

Compared with the existing technology, the beneficial effects of this invention are:

(1) Ag-GNSs are used as reinforcing phases for the composite solders due to its excellent mechanical, thermal and electrical properties, while the nano-silver particles are embedded in the graphene sheets The nano-silver particles embedded in the graphene layer, so that when combined with the matrix material can ease nano-silver modified graphene reunion, and make composite material composition more uniform. At the meantime, the addition of fine nano-silver particles can also improve the load-transfer between the Sn-based and the nano-silver modified graphene, thereby further improving the reliability of the joint and achieving better strong effects;

(2) The ball-milling process is adopted to prepare the composite solders. Mechanical energy during the ball-milling process can induce chemical reactions or changes in the texture, structure and properties of the material, with the obvious advantages of reducing reaction activation energy, refining grains, greatly improving powder activity and particle distribution uniformity.

### BRIEF DESCRIPTION OF THE DRAWINGS

FIG. 1 Comparison of wetting angle between conventional Sn—Ag—Cu lead-free solders and Example 1, Example 2 and Example 3;

FIG. 2 Comparison of tensile strength between conventional Sn—Ag—Cu lead-free solders and Example 1, Example 2 and Example 3;

FIG. 3(a) Schematic diagram of IMC layer thickness after reflowing of conventional Sn—Ag—Cu lead-free solders;

FIG. 3(b) Schematic diagram of IMC layer thickness after reflowing of Example 1, ie Sn-based silver-graphene lead-free composite solders containing 0.03% silver-graphene nanosilver (AG-GNSs);

FIG. 3(c) Schematic diagram of IMC layer thickness after reflowing of Example 2, ie Sn-based silver-graphene lead-free composite solders containing 0.05% silver-graphene nanosilver (AG-GNSs);

FIG. 3(d) Schematic diagram of IMC layer thickness after reflowing of Example 3, ie Sn-based silver-graphene lead-free composite solders containing 0.1% silver-graphene nanosilver (AG-GNSs).

### DETAILED DESCRIPTION OF THE INVENTION WITH EMBODIMENTS

The design idea of the invention is to select graphene nanosheets (AG-GNSs) modified with nano-silver particles as a strengthening phase. The nano-silver particles embedded in the graphene layer, so that when combined with the matrix material can ease graphene reunion modified with nano-silver, and make composite material composition more uniform. Silver-graphene nanosheets are used to improve the performance of lead-free solders. Among them, the using of the ball-milling process can be prepared for ultrafine materials. Mechanical energy during the ball-milling process can induce chemical reactions or changes in the texture, structure and properties of the material, with the obvious advantages of reducing reaction activation energy, refining grains, greatly improving powder activity and particle distribution uniformity.

Below with reference to specific embodiments described in more detail the technical solution of the present invention, in embodiments of the present application carried out under the premise, gives a detailed embodiments and procedures, the protection scope of the present invention is not limited to the following embodiments case

### EXAMPLE 1

Preparation of Sn-based silver-graphene lead-free composite solders, which comprises the following steps:

Step 1, 30 mg of graphene and 10 mg of sodium lauryl sulfate are weighed on an electronic balance and then mixed. 40 ml of dimethylformamide is measured with a measuring cylinder. The mixed 30 mg of graphene and 10 mg of SDS (sodium lauryl sulfate) are added to 40 ml of DMF (dimethylformamide) and sonicated for 2 hours;

Step 2, then 20ml molar concentration of 0.06 mol/ml of silver nitrate solution is measured with a measuring cylinder, adding the mixture prepared in the step 1 to it and sonicating for 30 minutes to obtain better modification of the graphene. Then it is heated at 70° C. for 1 hour, filtered, washed with water and after that, washed with alcohol to obtain silver-graphene nanosheets (AG-GNSs);

Step 3, subsequently, a certain amount of 96.5Sn-3.0Ag-0.5Cu alloy powder was weighed and mixed with Ag-GNSs prepared in the step 2 (96.5Sn-3.0Ag-0.5Cu alloy powder is used as a matrix material, and the particle size of the matrix material is 25-45 μm).The mass fraction of the silver-graphene nanosheets in the mixed powder is 0.03%;

Step 4, the above mixed powder is put into a planetary ball-milling pot, and stainless steel ball (ball-milling medium) and a certain amount of ethanol (ethanol is added cover the stainless steel balls in the ball mill jar and powder) are added. After sealing the vacuum and adding a certain amount of high-purity argon gas as shielding gas, the planetary ball-milling pot runs at 300 r/min speed for 5 h, and the matrix material and the reinforcing phase are fully mixed, so that the silver-graphene nanosheets are uniformly distributed in the lead-free solders matrix material;

Step 5, the powder mixed in step 4 is poured into a diameter of 20 mm stainless steel mold after drying. The uniaxial cold forming is carried out in a hydraulic press under 500 MPa pressure;

Step 6, the cylinder after cold-pressed in step 5 is put into a high vacuum tube resistance furnace, sintering at 175° C. for 2 h in vacuum, then it's take out after cooling to room temperature;

Step 7, the cylinder sample after sintering in step 6 is put into a punching mold, punched into a rod diameter of 6 mm in a hydraulic machine, then Sn-based silver-graphene lead-free composite solders is obtained.

### EXAMPLE 2

Preparation of Sn-based silver-graphene lead-free composite solders, the procedure is essentially as same as in Example 1, but the only difference is that:

Step 3, when 96.5Sn-3.0Ag-0.5Cu alloy powder is mixed with silver-graphene nanosilver (AG-GNSs), the mass fraction of silver-graphene nanosheets in the mixed powder is 0.05%.

### EXAMPLE 3

Preparation of Sn-based silver-graphene lead-free composite solders, the procedure is essentially as same as in Example 1, but the only difference is that:

Step 3, when 96.5Sn-3.0Ag-0.5Cu alloy powder is mixed with silver-graphene nanosilver (AG-GNSs), the mass fraction of silver-graphene nanosheets in the mixed powder is 0.1%.

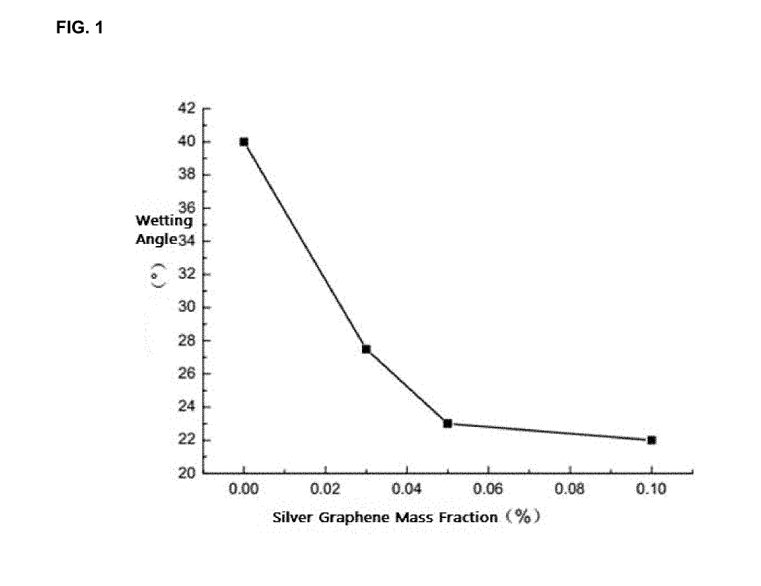

FIG. 1 is a comparison of wetting angle between the existing Sn—Ag—Cu lead-free solders and Sn-based silver-graphene lead-free composite solders prepared in Example 1, Example 2 and Example 3. As can be seen from FIG. 1, with the silver-graphene nanosheets mass fraction increases, the wetting angle also decreases gradually from 40° without adding to 22° in Example 3.

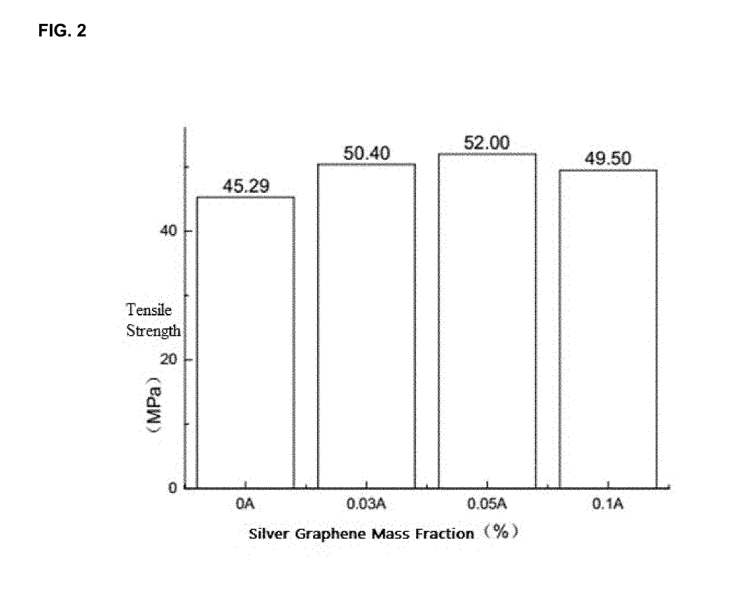

FIG. 2 is a comparison of tensile strength between the existing Sn—Ag—Cu lead-free solders and Sn-based silver-graphene lead-free composite solders prepared in Example 1, Example 2 and Example 3. As can be seen from FIG. 2, the addition of silver-graphene nanosheets increases the tensile strength of the composite solder. When the mass fraction of additive silver-graphene nanosheets is 0.05%, the tensile strength has the most significant increase than the non-addition, up to 14.8%.

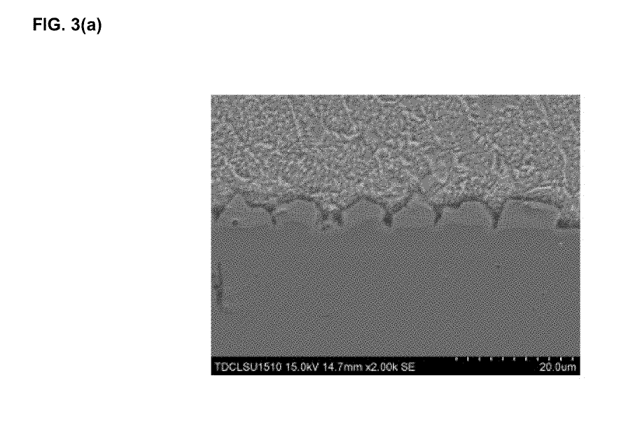

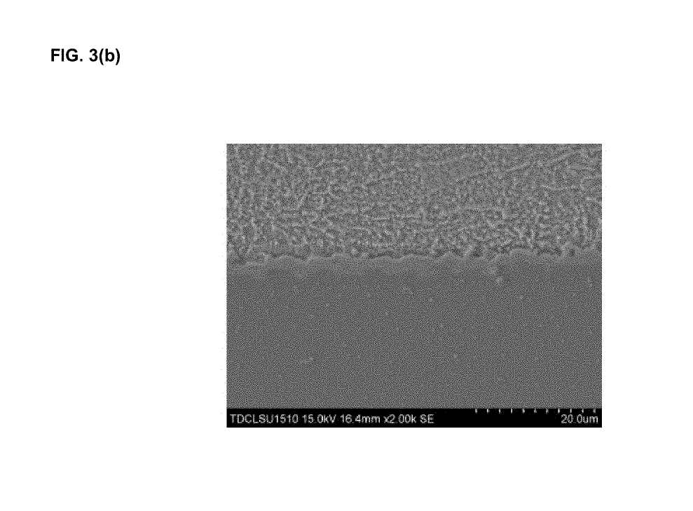

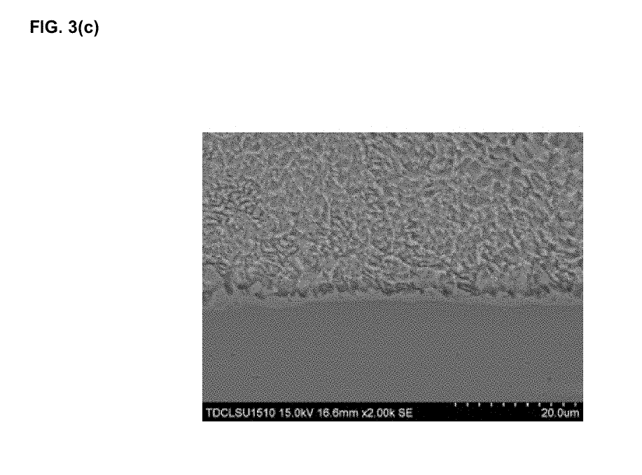

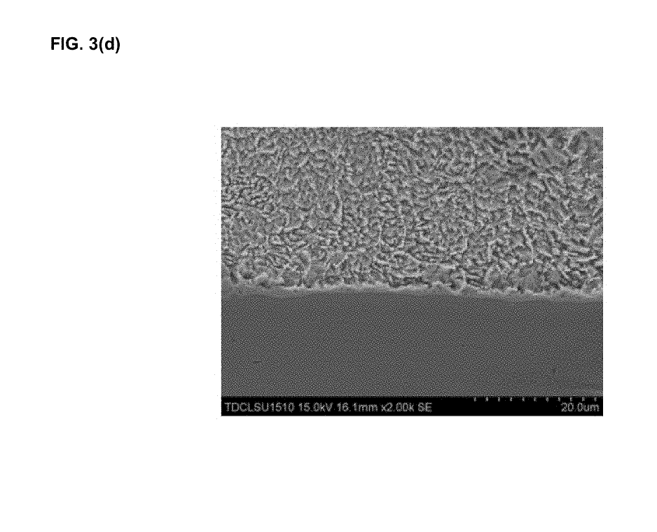

FIG. 3 is a comparison of IMC layer thickness after reflowing between the existing Sn—Ag—Cu lead-free solders and Sn-based silver-graphene lead-free composite solders prepared in Example 1, Example 2 and Example 3. As can be seen from FIG. 3, with the mass fraction of silver-graphene nanosheets increased, IMC layer gradually decreases, indicating that silver-based nanosheets on IMC formation has played a good inhibitory effect.

As can be seen from FIG. 1, FIG. 2 and FIG. 3, when the content of silver-graphene nanosheets increases from 0.03% to 0.1%, the mechanical properties, wettability and IMC growth of the composite solders have been improved, compared with the non-addition, however, when the content increased to 0.1%, compared to 0.05% content of silver-graphene nanosheets, they haven't been significantly improved, even in the tensile properties of a slight decline. Therefore, this invention suggests that the mass fraction of the silver-graphene nanosheet is 0.03-0.05%, preferably 0.05%.

Although this invention has been described with reference to the accompanying drawings above, this invention is not limited to the above specific embodiment. The foregoing specific embodiments are merely illustrative and not restrictive. General skillful people in this field, under the inspiration of this invention, can make many variations without departing from the spirit of this invention, all of which are within the protection of this invention.

What is claimed is:

1. A method for preparing a kind of Sn-based silver-graphene lead-free composite solders, characterized by comprising the following steps:
step 1, according to the mass ratio of 3:1 weighed graphene mixed with sodium lauryl sulfate as the mixture A, then uses a container to get some dimethylformamide, and the mixture A was added to dimethylformamide to obtain a mixture, wherein mass ratio of the mixture A to dimethylformamide is 1:1, the unit is mg/ml, and the mixture is sonicated for 2 hours;
step 2, the molar concentration of 0.06 mol/ml of silver nitrate solution is added to a mixture of step 1, wherein the volume ratio of the silver nitrate solution to dimethylformamide is 1:2, sonicated for 30 minutes and filtered after heating for 1 hour at 70° C., followed by washing and alcohol cleaning, then silver-graphene nanosheets were obtained;
step 3, taking 96.5Sn-3.0Ag-0.5Cu alloy powder as matrix material, the particle size of the matrix material is 25-45 μm. Appropriate amount of silver-graphene nanosheets as the reinforcing phase is take and mixed with the matrix material as the mixture B, wherein the mass percentage of the silver-graphene nanosheets is 0.03% to 0.1%;
step 4, the mixture B is poured into a planetary ball mill tank, and added a certain amount of ethanol which is just cover the mixture B in the ball-milling tank and some stainless steel balls as a kind of ball-milling medium; then sealed vacuum and set argon as a protective gas to run at 300 r/min speed 5 h, a matrix material and silver-graphene nanosheets fully mixed powder is obtained; step 5, after drying the mixed powder in step 4, it's poured into a diameter of 20 mm stainless steel mold and the uniaxial cold forming is carried out in a hydraulic press under 500 MPa pressure;
step 6, the cylinder after cold-pressed in step 5 is put into a high vacuum tube resistance furnace, sintering at 175° C. for 2 h in vacuum, then it's take out after cooling to room temperature;
step 7, the cylinder sample after sintering in step 6 is put into a punching mold, punched into a rod diameter of 6 mm in a hydraulic machine, then Sn-based silver-graphene lead-free composite solders is obtained.

2. The method for preparing a kind of Sn-based silver-graphene lead-free composite solders according to claim 1, characterized in that, in the third step, the mass percentage of the silver-graphene nanosheet is 0.03-0.05%.

3. The method for preparing a kind of Sn-based silver-graphene lead-free composite solders according to claim 2, characterized in that, in the third step, the mass percentage of the silver-graphene nanosheet is 0.03%.

4. The method for preparing a kind of Sn-based silver-graphene lead-free composite solders according to claim 2, characterized in that, in the third step, the mass percentage of the silver-graphene nanosheet is 0.05%.
